(19) United States
(12) Patent Application Publication
(10) Pub. No.: US 2026/0184927 A1
(43) Pub. Date: Jul. 2, 2026

(54) CARBON BLACK HAVING IMPROVED STABILITY AND BIOCOMPATIBILITY, METHOD FOR PREPARING SAME, AND USES THEREOF

(71) Applicant: GBIONIC CO., LTD., Cheongju-si, Chungcheongbuk-do (KR)

(72) Inventors: Won Il CHOI, Seoul (KR); Onbeol KIM, Seoul (KR); Hyeonyeol RYU, Incheon (KR)

(73) Assignee: GBIONIC CO., LTD., Cheongju-si, Chungcheongbuk-do (KR)

(21) Appl. No.: 19/129,532

(22) PCT Filed: Nov. 3, 2023
(86) PCT No.: PCT/KR2023/017481

§ 371 Date: May 13, 2025

(30) Foreign Application Priority Data
Nov. 18, 2022 (KR) 10-2022-0154972

(51) Int. Cl. C09C 1/56; C09C 3/10

(52) U.S. Cl. CPC C09C 1/56; C09C 3/10; C01P 2004/64

(57) ABSTRACT

Please cancel the abstract of this application and replace it with the following amended abstract presented in clean form according to the procedures outlines in MPEP 714(II)(B): The present invention relates to carbon black having improved stability and biocompatibility, a method for producing the same, and uses thereof. More particularly, the present invention relates to carbon black coated with a Pluronic polymer, a method for preparing the same, and its use in cosmetics, inks (e.g., for semi-permanent makeup), paints, rubber, antistatic agents, semiconductive or conductive materials.

### CROSS-REFERENCE TO RELATED APPLICATIONS

This application is a national stage entry under 35 U.S.C. § 371 of International Application No. PCT/KR2023/017481 filed on Nov. 3, 2023, which claims priority to Korean Patent Application No. 10-2022-0154972 filed on Nov. 18, 2022, the entire contents of each of which are incorporated herein by reference.

### TECHNICAL FIELD

The present invention relates to carbon black having improved stability and biocompatibility, a method for producing the same, and uses thereof. More particularly, the present invention relates to carbon black coated with a pluronic polymer, a method for preparing the same, and its use in cosmetics, inks (e.g., for semi-permanent makeup), paints, rubber, antistatic agents, semiconductive or conductive materials.

### BACKGROUND

Carbon black, an inorganic pigment, exhibits excellent light resistance, water resistance, heat resistance, acid resistance, and alkali resistance, and is therefore widely used in various industrial fields. Until the 1960s, carbon black was mainly used in foods, pharmaceuticals, and cosmetics. However, concerns were later raised regarding the potential elution of polynuclear aromatic hydrocarbon(PNA's or PAH's), such as 3,4-benzoanthracene, which are known carcinogens, leading to restrictions on its use. These regulations began to ease in 2004, when the use of carbon black purified to a high degree of purity was permitted by the Cosmetic, Toiletry, and Fragrance Association (CTFA) in the United States.

Carbon black is composed of carbon and, due to the inherent properties of carbon, exhibits a strong tendency to aggregate. Although the smallest unit of carbon black is a primary particle, in practical products, it exists as a secondary aggregate formed by the agglomeration of primary particles. These aggregates are extremely small in size and tend to further entangle with each other, making it difficult to achieve a well-dispersed state. Furthermore, unlike conventional pigments where deeper color can be easily obtained by increasing the amount added, carbon black exhibits a limitation in color development. Once a certain threshold is reached, additional amounts do not lead to further blackening, making it challenging to adjust color intensity.

As an example of pigment application, when carbon black is used as a cosmetic pigment, its poor dispersibility and limited color adjustment become significant obstacles to its use. Therefore, in order to apply carbon black in cosmetic compositions—particularly for eye makeup products such as mascara and eyeliner, where the realization of true black is strongly desired—it is essential to improve both dispersibility and tinting strength. In addition, ensuring good storage stability of carbon black is also required.

Meanwhile, tattoos involve creating small wounds in the skin or subcutaneous tissue and introducing a pigment composition to form permanent markings such as letters or patterns. Semi-permanent makeup, which involves long-lasting coloration of areas such as the eyebrows, eyeliner, lips, or hairline, is one example. Recently, tattoos and semi-permanent makeup have gained popularity as means of either compensating for physical features or expressing individuality. Since tattoos involve the insertion of pigments into the skin, ensuring the safety of such pigments is critical. However, there have been continuous reports of harmful substances, such as heavy metals like lead and nickel, being detected in conventional dyes, which may cause cancer or allergic reactions. In addition, adverse effects have frequently been reported, such as pain, blisters, swelling, and mild inflammation after procedures on areas like the eyebrows, or symptoms such as pain and visual disturbance when the dye enters the eyes following eyeliner application.

### PRIOR ART DOCUMENT

Korean Patent Publication No. 10-2008-0011542

### SUMMARY

### Technical Problem

The present inventors have made great efforts to develop carbon black nanoparticles having excellent stability and biocompatibility for use in cosmetic compositions, especially semi-permanent makeup, and as a result, have confirmed that when carbon black is coated with a Pluronic polymer, not only are the dispersion stability, freeze-drying stability, and biocompatibility excellent, but the color can also be stably maintained without color fading or blue tinting when used as a tattoo dye, and thus have completed the present invention.

A schematic diagram of a method for preparing carbon black nanoparticles coated with a Pluronic polymer according to the present invention and its efficacy is shown in FIG. 1.

### Technical Solution

It is an object of the present invention to provide a Pluronic/carbon black nanoparticle composite with improved stability and biocompatibility, comprising:
(A) carbon black nanoparticles; and
(B) a Pluronic polymer coated on the surface of the carbon black nanoparticles.

In the Pluronic/carbon black nanoparticle composite of the present invention, the Pluronic polymer and the carbon black nanoparticles have a weight ratio of 0.5:1 to 50:1.

In the Pluronic/carbon black nanoparticle composite of the present invention, the Pluronic polymer is represented by Chemical Formula 1:

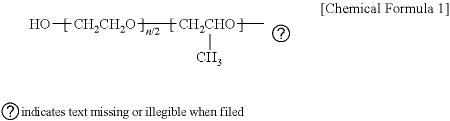

(wherein n is an integer from 8 to 540, and m is an integer from 16 to 70).

In the Pluronic/carbon black nanoparticle composite of the present invention, the Pluronic polymer is represented by Chemical Formula 2:

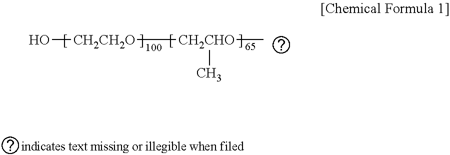

In the Pluronic/carbon black nanoparticle composite of the present invention, the Pluronic/carbon black nanoparticle composite is used for hair, skin, eyes, eyebrows, or eyelashes.

It is an object of the present invention to provide a cosmetic composition comprising the Pluronic/carbon black nanoparticle composite according to the present invention as an active ingredient.

In the cosmetic composition of the present invention, the cosmetic composition is formulated as an eyeshadow, eyebrow, eyeliner, mascara, eyebrow quick tattoo, aegyosal shadow liner, shade and shadow, shading, contouring, concealer, compact, foundation, base highlighter, lipstick, lip tint, tint drip balm, lip gloss, hair powder, hair powder spray, hairline cover, gray hair cover, hair dye, or dye shampoo.

It is an object of the present invention to provide an ink comprising the Pluronic/carbon black nanoparticle composite according to the present invention.

In the ink of the present invention, the ink is used for corneal tattooing, nipple tattooing, areola tattooing, scar tattooing, radiation therapy marking, eyebrow tattooing, eyeliner tattooing, lip tattooing, scalp tattooing, scalp hair powder tattooing, sideburn tattooing, beard tattooing, pubic hair tattooing, or henna tattooing.

It is an object of the present invention to provide a paint comprising the Pluronic/carbon black nanoparticle composite according to the present invention.

### Advantageous Effects

The Pluronic/carbon black nanoparticle composite according to the present invention exhibits excellent dispersion stability, freeze-drying stability (Examples 1 to 4), and biocompatibility (Experimental Example 1). It not only does not affect oxidative stress in cells (Experimental Example 2), but also provides the advantage of maintaining stable color without color fading or a bluish tint when used as a tattoo dye (Experimental Example 3). Therefore, the Pluronic/carbon black nanoparticle composite according to the present invention is expected to be stably used not only in cosmetic compositions, inks (e.g., semi-permanent makeup), and paints but also in medical materials.

### BRIEF DESCRIPTION OF THE DRAWINGS

FIG. 1 is a schematic diagram illustrating the method of manufacturing the Pluronic-coated carbon black nanoparticles according to the present invention and their efficacy.

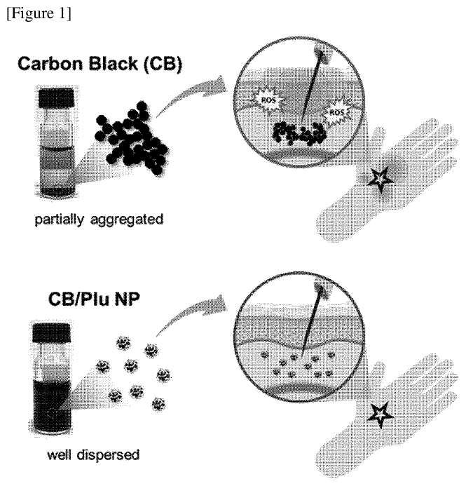

FIG. 2 shows (A) a photograph, (B) UV-Vis spectra, (C) size, (D) particle size distribution, and (E) dispersion value of the Pluronic-coated carbon black nanoparticles (CB/Plu NP) prepared in an embodiment of the present invention.

FIG. 3 demonstrates the dispersion stability of the CB/Plu NP prepared in the embodiment of the present invention after storing at room temperature for 4 weeks, showing (A) a photograph and (B) UV-Vis spectra in deionized water (DIW) and (C) PBS.

FIG. 4 shows the freeze-drying stability of the CB/Plu NP prepared in an embodiment of the present invention, with (A) size and (B) dispersion values of nanoparticles after freeze-drying (FD) and re-dispersion in DIW and PBS.

FIG. 5 shows (A) a photograph, (B) UV-Vis spectra, (C) size, (D) dispersion values, and (E) FT-IR spectra of CB, PF127, and CB/PF127 NP (1:5) of the CB/Plu 127 NP prepared in the embodiment of the present invention.

FIG. 6 demonstrates the dispersion stability of the CB/Plu 127 NP prepared in the embodiment of the present invention after storing at room temperature for 4 weeks, showing (A) a photograph and (B) UV-Vis spectra in DIW and (C) PBS.

FIG. 7 shows the dispersion stability of the CB/Plu 127 NP prepared in the embodiment of the present invention, with (A) size and (B) dispersion values in DIW after 4 weeks at room temperature and (C) size and (D) dispersion values in PBS.

FIG. 8 demonstrates the freeze-drying stability of the CB/Plu 127 NP prepared in the embodiment of the present invention, with (A) size and (B) dispersion values of nanoparticles after freeze-drying (FD) and re-dispersion in DIW and PBS.

FIG. 9 shows the cell toxicity results (A) and cell morphology (B) for different CB/PF127 NP ratios (i) negative control (Neg), (ii) positive control (Pos), (iii) 1:0, (iv) 1:2, (v) 1:5, and (vi) 1:10.

FIG. 10 shows the results of reactive oxygen species (ROS) radical scavenging activity for the different CB/PF127 NP ratios prepared in the embodiment of the present invention.

FIG. 11 demonstrates the tattoo retention ability over 16 weeks for the different CB/PF127 ratios prepared in the embodiment of the present invention.

FIG. 12 shows the H&E staining analysis results of the treated area after 16 weeks for different CB/PF127 ratios prepared in the embodiment of the present invention: (A) 1:2, (B) 1:5, and (C) 1:10.

FIG. 13 shows a photograph of tattoos applied with CB/PF127 NP (1:5) and a commercial product (CTL, Company A) after 1 week.

### DETAILED DESCRIPTION

Hereinafter, carbon black having improved stability and biocompatibility, a method for producing the same, and uses thereof according to specific embodiments of the present disclosure will be described in detail. However, these are for illustrative purposes only, and the scope of the present disclosure is not intended to be limited thereby. It will be apparent to those skilled in the art that various modifications may be made thereto without departing from the scope of the present disclosure. In addition, the term “including” or “containing” means including a particular component (or particular element) without particular limitations unless otherwise mentioned in the present entire disclosure, and it cannot be interpreted as excluding the addition of the other components.

The term “Pluronic polymer,” as used herein, refers to an amphiphilic block copolymer having a polyethylene oxide (PEO)-polypropylene oxide (PPO)-polyethylene oxide (PEO) structure. It offers several advantages, including a stable chemically cross-linked structure, stability in both in vitro and in vivo environments, ease and efficiency of protein loading, low cytotoxicity, and temperature sensitivity.

According to a first embodiment, the present invention provides a Pluronic/carbon black nanoparticle complex having improved stability and biocompatibility, comprising:
(A) carbon black nanoparticles; and
(B) a Pluronic polymer coated on the surface of the carbon black nanoparticles.

In the Pluronic/carbon black nanoparticle complex of the present invention, the weight ratio of the Pluronic polymer to the carbon black nanoparticles may range from 0.5:1 to 50:1, preferably from 2:1 to 20:1, and more preferably from 5:1 to 10:1.

In the Pluronic/carbon black nanoparticle complex of the present invention, the Pluronic polymer may be represented by the following Chemical Formula 1:

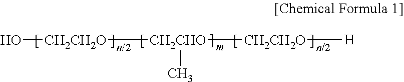

(wherein n is an integer from 8 to 540, and m is an integer from 16 to 70.) In the Pluronic/carbon black nanoparticle complex of the present invention, the Pluronic polymer may be Pluronic F127, which is represented by Chemical Formula 2:

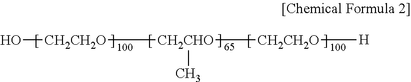

In the Pluronic/carbon black nanoparticle complex of the present invention, the diameter of the Pluronic/carbon black nanoparticle complex may be from 1 to 300 nm, preferably from 1 to 250 nm.

In the Pluronic/carbon black nanoparticle complex of the present invention, the Pluronic/carbon black nanoparticle complex may be used in applications related to hair, skin, eyes, eyebrows, or eyelashes.

According to a second embodiment,
the present invention provides a cosmetic composition comprising a Pluronic/carbon black nanoparticle complex having improved stability and biocompatibility, which comprises carbon black nanoparticles and a Pluronic polymer coated on the surface of the carbon black nanoparticles as an active ingredient.

In the cosmetic composition, the Pluronic polymer and the carbon black nanoparticles may have a weight ratio of 0.5:1 to 50:1, or 0.5:1 to 40:1, preferably 2:1 to 20:1, and more preferably 5:1 to 10:1.

In the cosmetic composition, the Pluronic polymer may be Pluronic F127.

In the cosmetic composition, the cosmetic composition may be formulated as one or more selected from the group consisting of eye shadow, eyebrow, eyeliner, mascara, eyebrow quick tattoo, aegyo-sal shade liner, shade and shadow, shading, contouring, concealer, pact, foundation, base highlighter, lipstick, lip tint, tinted lip balm, lip gloss, black dye, black dye spray, hairline cover, gray hair cover, hair dye, or dye shampoo.

According to a third embodiment,
the present invention provides an ink composition comprising a Pluronic/carbon black nanoparticle complex having improved stability and biocompatibility, which comprises carbon black nanoparticles and a Pluronic polymer coated on the surface of the carbon black nanoparticles as an active ingredient.

In the ink composition, the Pluronic polymer and the carbon black nanoparticles may have a weight ratio of 0.5:1 to 50:1, or 0.5:1 to 40:1, preferably 2:1 to 20:1, and more preferably 5:1 to 10:1.

In the ink composition, the Pluronic polymer may be Pluronic F127.

In the ink composition, the ink may be used for corneal tattoos, nipple tattoos, areola tattoos, scar tattoos, radiotherapy markers, eyebrow tattoos, eyeliner tattoos, lip tattoos, scalp tattoos, scalp black tattoos, sideburn tattoos, beard tattoos, pubic tattoos, or henna tattoos.

In the ink according to the present invention, the ink may be used for printing packaging packages, wrapping paper, wallpaper, fibers, cosmetic plates, textiles, various films, or labels.

In the ink according to the present invention, the ink can be used to print packaging packages, wrapping paper, wallpaper, fibers, cosmetic boards, textiles, various films or labels.

According to a fourth embodiment,
the present invention provides a paint composition comprising a Pluronic/carbon black nanoparticle complex having improved stability and biocompatibility, which comprises carbon black nanoparticles and a Pluronic polymer coated on the surface of the carbon black nanoparticles as an active ingredient.

In the paint composition, the Pluronic polymer and the carbon black nanoparticles may have a weight ratio of 0.5:1 to 50:1, or 0.5:1 to 40:1, preferably 2:1 to 20:1, and more preferably 5:1 to 10:1.

In the paint composition, the Pluronic polymer may be Pluronic F127.

In the paint composition, the paint may be used for exteriors of automobiles, motorcycles, and bicycles, building materials, tiles, furniture, household goods, containers, office supplies, or sports equipment.

The Pluronic/carbon black nanoparticle complex according to the present invention can be used in addition to the aforementioned uses, such as in rubber, antistatic agents, and semiconductive or conductive materials.

In one exemplary embodiment, the Pluronic/carbon black nanoparticle complex can be used in rubber, for example, in automobile, aircraft, or industrial tires.

In another exemplary embodiment, the Pluronic/carbon black nanoparticle complex can be used as an antistatic agent, for example, in housings, cassettes, mechanical parts of electrical products, vehicle fuel tanks, hoses for chemical solvents, conveyor belts, V-belts, safety shoes, copier rollers, explosion-proof containers, integrated circuit packages(IC package), storage facilities, trays, containers, film rolls, video or audio magnetic tapes, or a backing of a carpet in computer rooms.

In yet another exemplary embodiment, the Pluronic/carbon black nanoparticle complex can be used as a semiconductive or conductive material, such as in semiconductive compounds cross-linked polyethylene cables, ignition cables, communication cables, or next-generation storage batteries (Zn—Br type and Zn—Cl type).

According to a fifth embodiment,
the present invention provides a method for preparing a Pluronic/carbon black nanoparticle complex having improved stability and biocompatibility, the method comprising the step of:
dissolving a Pluronic polymer and carbon black nanoparticles, and reacting the mixture at room temperature for 30 minutes to 2 hours.

In the method for preparing a pluronic/carbon black nanoparticle complex according to the present invention, the Pluronic polymer and the carbon black nanoparticles may have a weight ratio of 0.5:1 to 50:1, or 0.5:1 to 40:1, preferably 2:1 to 20:1, and more preferably 5:1 to 10:1.

In the method for preparing a pluronic/carbon black nanoparticle complex according to the present invention, the Pluronic polymer may be Pluronic F127.

In the method for preparing a pluronic/carbon black nanoparticle complex according to the present invention, the diameter of the Pluronic/carbon black nanoparticle complex may be 1 to 300 nm, preferably 1 to 250 nm.

### EXAMPLES

Hereinafter, various embodiments are presented to aid understanding of the present disclosure. The following embodiments are provided merely for easier understanding of the present disclosure, and it should be understood that the scope of the present disclosure is not limited to the following embodiments.

### Example 1

### Example 1. Preparation of Pluronic-Coated Carbon Black Nanoparticles

Five types of Pluronic polymers (PF68, PF127, PL35, PP123, and PL81; each 25 mg) were dissolved in 1 mL of deionized water (DIW). The resulting Pluronic solution was added to carbon black (CB; 5 mg), transferred to a 20 mL vial, and stirred magnetically at 300 rpm for 30 minutes. Subsequently, 4 mL of DIW was added, and the mixture was further stirred at 450 rpm for an additional 30 minutes. Homogenization was performed using an ultrasonic homogenizer (amplitude=20%, 5 sec on/15 sec off) for 1 hour. Uncoated CB was removed via centrifugation (2,000 rpm, 10 minutes), and the resulting product was freeze-dried for 3 days.

### Example 2. Characterization of Pluronic-Coated Carbon Black Nanoparticles

### 2-1. Visual Observation of CB/Pluronic Nanoparticles

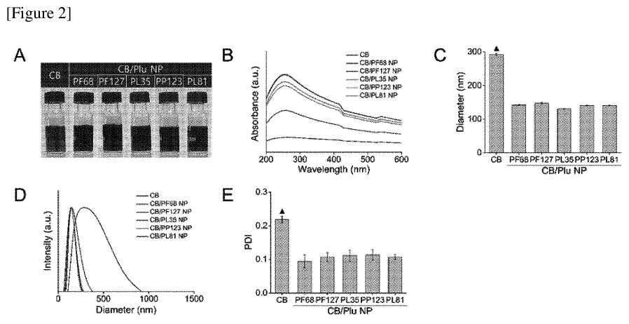

Upon visual observation and photographic imaging of the CB/Pluronic nanoparticles (CB/Plu NPs) prepared in Example 1, the uncoated CB NPs exhibited poor dispersibility, with partial precipitation (▴) and a light color. In contrast, the CB/Plu NPs appeared darker, indicating an increased yield of CB. These results confirm that the dispersibility of CB was enhanced upon Pluronic coating (FIG. 2a).

### 2-2. Absorbance of CB/Pluronic Nanoparticles

UV-Vis spectroscopic analysis of the CB/Plu NPs from Example 1 revealed that the absorbance of uncoated CB NPs was very low. However, absorbance significantly increased following Pluronic coating. Notably, CB/Plu NPs coated with PF68 and PF127, which possess high hydrophilic-lipophilic balance (HLB) values, exhibited the highest absorbance, indicating enhanced CB yield (FIG. 2b).

### 2-3. Particle Size, Polydispersity Index (PDI), and Surface Charge of CB/Pluronic Nanoparticles

Particle size, polydispersity index (PDI), and surface charge of the CB/Plu NPs prepared in Example 1 were analyzed using a Zetasizer (EL SZ-2000, Otsuka). The particle size of uncoated CB NPs was approximately 290 nm and showed partial precipitation. After Pluronic coating, the size of the CB/Plu NPs was reduced to approximately 140 nm (FIG. 2c). Moreover, the PDI was found to be below 0.3, indicating the production of uniformly sized nanoparticles (FIGS. 2d-2e).

### Example 3. Stability Evaluation of Pluronic-Coated Carbon Black Nanoparticles

### 3-1. Dispersion Stability

To evaluate the dispersion stability of CB and CB/Plu NPs prepared in Example 1, the nanoparticle suspensions were stored in DIW or phosphate-buffered saline (PBS) at room temperature (25° C.) for 4 weeks. Photographs were taken periodically, and UV-Vis spectra were recorded.

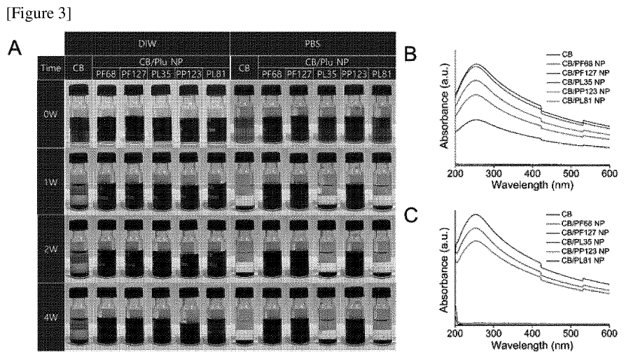

Uncoated CB NPs showed partial precipitation as early as the first week of storage in DIW. In contrast, CB/Plu NPs maintained stable dispersion and color for the entire 4-week period. Particularly, CB/Plu NPs coated with PF68 and PF127 remained stable even in PBS, a more stringent condition (FIG. 3A). UV-Vis analysis also confirmed that PF127-coated CB exhibited the highest absorbance after 4 weeks in both DIW and PBS, indicating superior dispersion stability (FIGS. 3B and 3C).

### 3-2. Freeze-Drying Stability

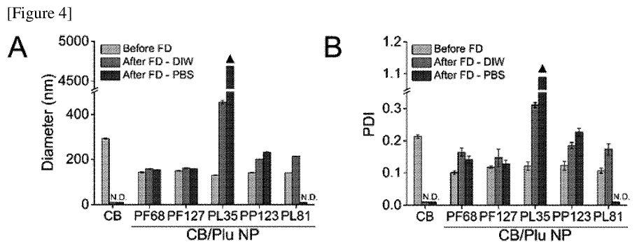

The freeze-drying stability was assessed by comparing the particle size and PDI before freeze-drying and after redispersion in DIW or PBS. In the case of CB, CB/PL35 NPs, and CB/PL81 NPs, precipitation occurred after freeze-drying, making further evaluation impossible (N.D.) or leading to a substantial increase in particle size and PDI. In contrast, CB/PF68 NPs and CB/PF127 NPs maintained consistent size and dispersion characteristics after freeze-drying, demonstrating high freeze-drying stability (FIG. 4). Based on yield, dispersion stability, and freeze-drying stability, CB/PF127 NP was identified as the optimal formulation for further study.

### Example 4. Evaluation of Carbon Black Nanoparticles According to the Coating Ratio of

### Pluronic Polymer

### 4-1. Experimental Method

To assess the effect of the Pluronic coating ratio, Pluronic solutions at different concentrations (2.5, 5, 10, 25, 50, and 250 mg in 1 mL of DIW) were reacted with 5 mg of CB under the same conditions as in Example 1 to prepare CB/PF127 NPs. These were then evaluated using the characterization and stability assessment protocols described in Examples 2 and 3.

### 4-2. Characterization Results

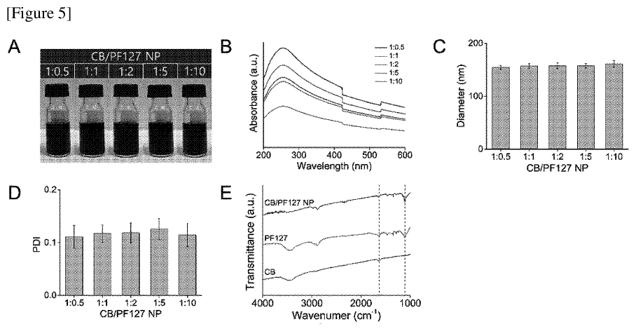

At all tested ratios, the resulting CB/PF127 NPs exhibited a dark black color, indicating good dispersion of CB. The average particle size was approximately 150 nm, and the PDI remained below 0.3 (FIG. 5).

### 4-3. Stability Evaluation

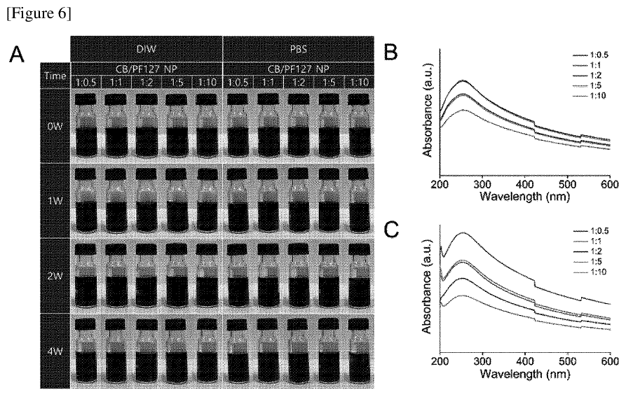

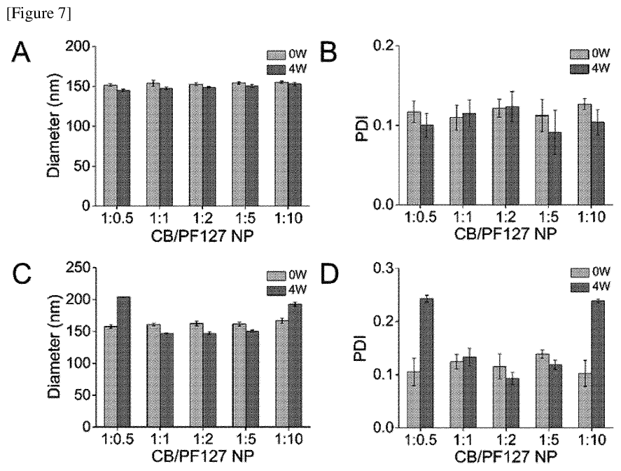

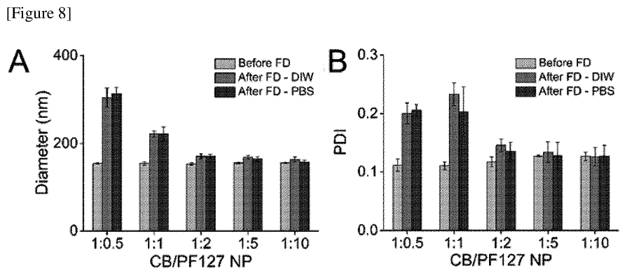

When stored in DIW and PBS for 4 weeks, no color change or precipitation was observed in any of the formulations, confirming high stability. Among them, the CB/PF127 NP at a 1:2 ratio exhibited the best dispersion stability, maintaining its properties without aggregation over time in both DIW and PBS (FIGS. 6-7). Additionally, freeze-drying stability tests revealed that while the size of nanoparticles increased post-freeze-drying in the 1:0.5 and 1:1 groups, the 1:2 group retained consistent particle size and dispersion characteristics, confirming excellent freeze-drying stability (FIG. 8).

### Experimental Example

### Experimental Example 1. In Vitro Cytotoxicity and Biocompatibility Evaluation of CB/PF127 Nanoparticles (NPs)

To evaluate the in vitro cytotoxicity and biocompatibility of uncoated carbon black (CB; 1:0) and CB/PF127 nanoparticles (NPs), fibroblasts and NIH 3T3 cells were cultured in Dulbecco's Modified Eagle's Medium (DMEM) supplemented with 10% fetal bovine serum (FBS) and 1% antibiotic-antimycotic (AA). The cells were seeded into 96-well plates at a density of 10,000 cells per well and incubated at 37° C. in a 5% CO₂ atmosphere for 12 hours. Subsequently, the cells were treated with CB/PF127 NPs at concentrations of 0.1 mg/mL and 1 mg/mL for 24 hours. Cell viability was then assessed using a CCK-8 assay kit.

The negative control group (Neg) was treated with culture medium alone, while the positive control group (Pos) was treated with 10% DMSO. To further examine cell morphology following NP exposure, NIH 3T3 cells were cultured in DMEM containing 10% FBS and treated with CB/PF127 NPs at various CB:PF127 ratios for 48 hours.

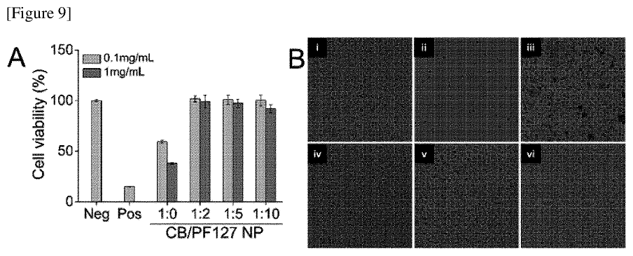

As a result, uncoated CB (1:0) exhibited significant cytotoxicity due to nanoparticle aggregation and precipitation, reducing cell viability to 38%. In contrast, CB/PF127 NPs demonstrated excellent biocompatibility across all tested ratios and did not induce any observable cytotoxicity. These findings confirm that the CB/PF127 NPs according to the present invention are safe and suitable for applications in cosmetic compositions, inks (e.g., semi-permanent cosmetic inks), and pharmaceutical formulations (FIG. 9).

### Experimental Example 2. Evaluation of Oxidative Stress Via In Vitro Induction of Reactive Oxygen Species (ROS) by CB/PF127 Nanoparticles (NPs)

NIH 3T3 cells were cultured in DMEM supplemented with 10% fetal bovine serum (FBS) and 1% antibiotic-antimycotic (AA). A total of 10,000 cells were seeded into each well of a 96-well plate and incubated for 12 hours. Subsequently, 200 L of CB/PF127 NPs (10 g/mL) at various CB:PF127 ratios were added to each well, and the cells were further incubated for 24 hours. For the control group (CTL), only culture medium was applied.

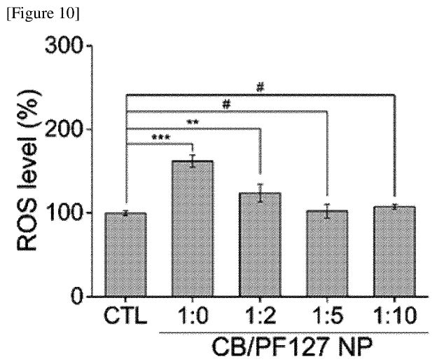

After incubation, the cells were washed with PBS to remove residual NPs, and intracellular reactive oxygen species (ROS) levels were measured using 10 M of H2DCFDA staining. As shown in FIG. 10, treatment with uncoated CB (1:0) and CB/PF127 NP (1:2) increased intracellular ROS production by approximately 160% and 120%, respectively, indicating increased oxidative stress. In contrast, treatment with CB/PF127 NP (1:5) and CB/PF127 NP (1:10) did not result in an increase in ROS levels, confirming that these formulations do not induce oxidative stress in cells (FIG. 10).

### Experimental Example 3. In Vitro Evaluation of Dyeing Properties of CB/PF127 Nanoparticles (NPs)

To evaluate the dyeing properties of the CB/PF127 NPs according to the present invention, 50 μL of each formulation was intradermally injected into 8-week-old Prague-Dawley rats. Uncoated CB (1:0) was excluded from the experiment due to aggregation and precipitation, which hindered administration through the injection needle.

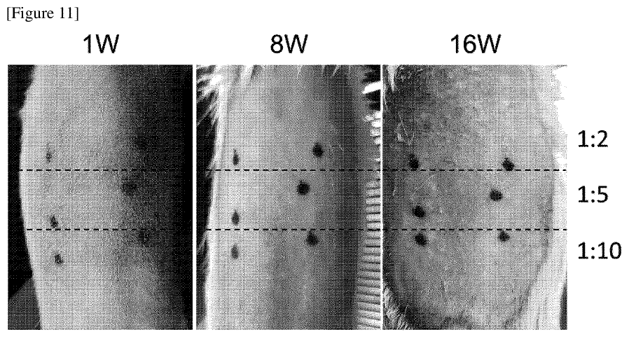

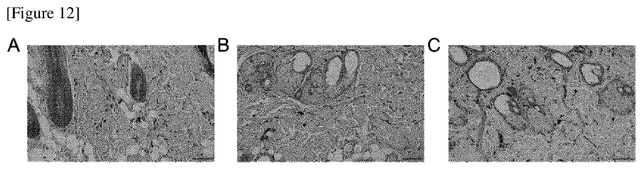

As shown in FIG. 11, the CB/PF127 NP formulations exhibited stable coloration without fading or bluish discoloration for up to 16 weeks post-injection. Furthermore, hematoxylin and eosin (H&E) staining of the injection sites confirmed that the CB/PF127 NPs remained in the skin without inducing inflammation for the full 16-week period (FIG. 12).

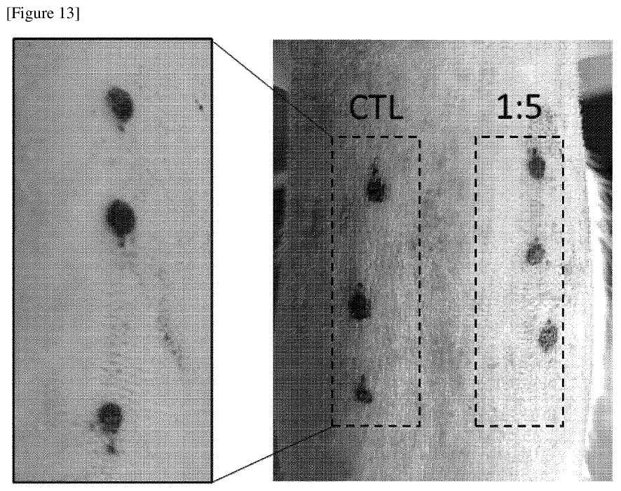

Notably, as illustrated in FIG. 13, the CB/PF127 NP (1:5) formulation showed superior color retention and stability compared to a commercially available tattoo ink (Control, CTL), which exhibited a noticeable blue tint and fading within one week. These results indicate that the CB/PF127 NPs of the present invention possess excellent stability and suitability for long-term cosmetic or medical tattoo applications (FIG. 13).

Although the present disclosure has been described in detail with reference to the specific features, it will be apparent to those skilled in the art that this description is only for a preferred example and does not limit the scope of the present disclosure. Thus, the substantial scope of the present disclosure will be defined by the appended claims and equivalents thereof.

### INDUSTRIAL APPLICABILITY

It is expected that the pluronic/carbon black nanoparticle complex according to the present invention can be stably used not only as a cosmetic composition, ink (e.g., semi-permanent makeup), and paint, but also as a medical material.

1. A Pluronic/carbon black nanoparticle composite with improved stability and biocompatibility, comprising:
(A) carbon black nanoparticles; and
(B) a Pluronic polymer coated on the surface of the carbon black nanoparticles.

2. The Pluronic/carbon black nanoparticle composite of claim 1,
wherein the Pluronic polymer and the carbon black nanoparticles have a weight ratio of 0.5:1 to 50:1.

3. The Pluronic/carbon black nanoparticle composite of claim 1,
wherein the Pluronic polymer is represented by Chemical Formula 1: 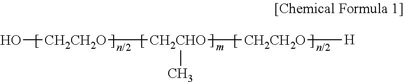
(wherein n is an integer from 8 to 540, and m is an integer from 16 to 70).

4. The Pluronic/carbon black nanoparticle composite of claim 3,
wherein the Pluronic polymer is represented by Chemical Formula 2:

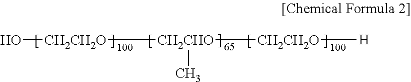

5. The Pluronic/carbon black nanoparticle composite of claim 1,
wherein the Pluronic/carbon black nanoparticle composite is used for hair, skin, eyes, eyebrows, or eyelashes.

6. A cosmetic composition comprising the Pluronic/carbon black nanoparticle composite according to claim 1 as an active ingredient.

7. The cosmetic composition of claim 6,
wherein the cosmetic composition is formulated as an eyeshadow, eyebrow, eyeliner, mascara, eyebrow quick tattoo, aegyosal shadow liner, shade and shadow, shading, contouring, concealer, compact, foundation, base highlighter, lipstick, lip tint, tint drip balm, lip gloss, hair powder, hair powder spray, hairline cover, gray hair cover, hair dye, or dye shampoo.

8. An ink comprising the Pluronic/carbon black nanoparticle composite according to claim 1.

9. The ink of claim 8,
wherein the ink is used for corneal tattooing, nipple tattooing, areola tattooing, scar tattooing, radiation therapy marking, eyebrow tattooing, eyeliner tattooing, lip tattooing, scalp tattooing, scalp hair powder tattooing, sideburn tattooing, beard tattooing, pubic hair tattooing, or henna tattooing.

10. A paint comprising the Pluronic/carbon black nanoparticle composite according to claim 1.

11. The paint of claim 10,
wherein the paint is used for exteriors of automobiles, motorcycles and bicycles, building materials, tiles, furniture, household goods, containers, office supplies, or sports equipment.

12. A rubber comprising the Pluronic/carbon black nanoparticle complex according to claim 1,
wherein the rubber is used in automobiles, aircraft, or industrial tires.

13. An antistatic agent comprising the Pluronic/carbon black nanoparticle complex according to claim 1,
wherein the antistatic agent is used in housings, cassettes, mechanical parts of electrical products, vehicle fuel tanks, hoses for chemical solvents, conveyor belts, V-belts, safety shoes, copier rollers, explosion-proof containers, integrated circuit packages(IC package), storage facilities, trays, containers, film rolls, video or audio magnetic tapes, or a backing of a carpet in computer rooms.

14. A semiconductive or conductive material comprising the Pluronic/carbon black nanoparticle complex according to claim 1,
wherein the semiconductive and conductive material is used in semi-conductive cross-linked polyethylene cables, ignition cables, communication cables, or next-generation storage batteries (Zn—Br type and Zn—Cl type).
